(19) United States
(12) Patent Application Publication
(10) Pub. No.: US 2026/0160551 A1
(43) Pub. Date: Jun. 11, 2026

(54) METHODS FOR WATER DEPTH INVERSION USING STOCHASTIC OPTIMAL RATIO LOGARITHMIC MODEL IN MULTI-SPECTRAL REMOTE SENSING

(71) Applicant: GUILIN UNIVERSITY OF TECHNOLOGY, Guilin (CN)

(72) Inventors: Guoqing ZHOU, Guilin (CN); Jiangying WU, Guilin (CN); Ertao GAO, Guilin (CN); Jiasheng XU, Guilin (CN); Jinwei LI, Guilin (CN)

(73) Assignee: GUILIN UNIVERSITY OF TECHNOLOGY, Guilin (CN)

(21) Appl. No.: 19/415,743

(22) Filed: Dec. 10, 2025

(30) Foreign Application Priority Data
Dec. 10, 2024 (CN) 202411812803.7

(51) Int. Cl. G01C 13/00; G06T 5/70; G06T 7/13; G06T 7/514; G06T 7/90

(52) U.S. Cl. CPC G01C 13/008; G06T 5/70; G06T 7/13; G06T 7/514; G06T 7/90; G06T 2207/10024; G06T 2207/10036; G06T 2207/20076; G06T 2207/30181

(57) ABSTRACT

The present disclosure relates to a method for multispectral remote sensing stochastic optimal ratio-logarithmic bathymetry inversion. The method addresses an issue that a water body signal is typically below 5%. The method comprehensively considers influences of a solar spectrum, an upward total scattering, a solar zenith angle, a total global transmittance, a direct irradiance, and a total spherical albedo. The method constructs an atmospheric coupled radiometric calibration correction model to correct atmospheric and water surface reflectance. The method corrects a tide height through a divided difference interpolation tide height correction model. The method accurately extracts a water body range by combining an FNDWI normalized difference water index. The method effectively extracts sub-datasets through a stochastic optimal model. The method optimizes model parameters of a ratio-logarithmic model using an extreme gradient boosting manner. The method obtains an optimized optimal ratio-logarithmic model for bathymetry inversion to achieve bathymetry inversion. A comparison is made between inversion results of the optimized optimal ratio-logarithmic model for bathymetry inversion and inversion results of a Stumpf model. The R² accuracy of the bathymetry inversion by the optimal ratio-logarithmic model for bathymetry inversion is improved by 0.592, and an RMSE is improved by 0.841 m.

### CROSS-REFERENCE TO RELATED APPLICATIONS

This application claims priority to the Chinese Patent Application No. 202411812803.7, filed on Dec. 10, 2024, the contents of which are hereby incorporated by reference.

### TECHNICAL FIELD

The present disclosure relates to the field of remote sensing technology, and in particular to a method for multispectral remote sensing stochastic optimal ratio-logarithmic bathymetry inversion.

### BACKGROUND

Bathymetric data provides important data support for maritime activities such as navigation of ships, monitoring of submarine topography and landforms, and monitoring of coastal ecosystems, and plays a key role in the field of marine research. Traditional bathymetric measurement manners are mainly based on onboard single-beam sonar, multi-beam sonar, and airborne light detection and ranging (LiDAR). Although traditional sonar bathymetry and airborne LiDAR manners have high measurement accuracy, a high cost of the traditional sonar bathymetry and airborne LiDAR manners is a main concern for researchers in the field of marine bathymetry. Therefore, a coverage range of the bathymetric data obtained by the traditional manners is limited, which restricts acquisition of bathymetry for large-scale and multi-reef areas. In recent years, bathymetry inversion technology based on multispectral remote sensing images has developed into an effective means to quickly and efficiently obtain large-scale and high-resolution bathymetric data. The bathymetry inversion technology uses measured bathymetric data as known data, combines sea surface spectral information, and constructs and trains an inversion model. Currently, acquisition of the measured bathymetric data still mainly relies on traditional manners such as onboard sonar and airborne LiDAR. However, a range of the measured bathymetric data obtained by the traditional manners is limited. Therefore, satellite bathymetry using multispectral remote sensing technology still faces many challenges, and accuracy and reliability of the satellite bathymetry still need further research.

An international patent “Shallow sea area bathymetry inversion method based on Sentinel-2A image” granted to Li Haibin et al. of the Chinese People's Liberation Army Unit 92859, with publication Ser. No. 114201732, proposes a method for bathymetry inversion in shallow sea areas based on Sentinel-2A images. The method preprocesses images, determines inversion factors, constructs and verifies a plurality of models, selects blue, green, and red bands with high correlation, combines Sentinel-2A images to select an optimal model for bathymetry inversion, and has advantages such as wide coverage, fast update speed, and low cost, effectively making up for deficiencies of traditional marine measurement manners.

An international patent “Method for selecting hyperspectral bathymetry inverse waveband” granted to Chen Jin et al. of the Beijing Institute of Remote Sensing Information, with publication Ser. No. 108240806, proposes a method for selecting hyperspectral bathymetry inversion bands. The method automatically selects bands using spectral band correlation and signal-to-noise ratio information, including band correlation analysis, grouping, signal-to-noise ratio analysis, bathymetry correlation analysis, and outputting bands according to requirements of a bathymetry inversion model.

An invention patent “A method for bathymetry inversion based on spaceborne LiDAR point cloud” applied for by Liu Zhendong et al. of Shandong University of Science and Technology, with patent number CN202410912661.5, proposes training and constructing a spaceborne LiDAR active-passive fusion bathymetry inversion model using submarine topography photons instead of in-situ bathymetry points, realizes refined extraction of submarine topography photons, and improves accuracy of bathymetry inversion.

An invention patent “A method for constructing dual-polarization SAR shallow sea bathymetry inversion based on physical constraint neural network” applied for by Xu Qing et al. of Ocean University of China, with patent number CN202410739992.3, introduces physical auxiliary information such as a polarization ratio of a synthetic aperture radar (SAR) remote sensing image and a wind field vector at an imaging moment, and solves a problem of large inversion error of submarine topography in bathymetry inversion in high-turbidity waters.

An invention patent “A method for bathymetry inversion using satellite remote sensing images” applied for by Yang Zhixiang et al. of China Railway Water Resources and Hydropower Planning and Design Group Co., Ltd., with patent number CN202311666078.2, is based on a water area representativeness index, screens optimal combination measurement points in sub-areas that do not meet standards, establishes a bathymetry inversion model according to reflectance, and enables acquisition of bathymetric data with relatively high accuracy when the water area changes.

An invention patent “A method for bathymetry inversion based on spaceborne active-passive remote sensing information at rising and falling tides” applied for by Yang Fanlin et al. of Shandong University of Science and Technology, with patent number CN202311666078.2, substitutes multispectral data at low tide of a spring tide into a constructed bathymetry inversion model to obtain a bathymetry inversion result of a deep-water area, and provides support for bathymetry inversion of coastal zone type II water bodies and bathymetric data in areas without measured bathymetric data.

An invention patent “A high-precision multi-temporal bathymetry inversion method, computing device, and storage medium” applied for by Yue Yuan et at of the East China Sea Laboratory of China University of Geosciences (Wuhan), with patent number CN202311489467.2, generates a plurality of single-temporal bathymetry inversion result datasets by constructing a bathymetry inversion model, integrates the a plurality of single-temporal bathymetry inversion result datasets into a plurality of temporal bathymetry inversion datasets and traverses the plurality of temporal bathymetry inversion datasets, uses a maximum outlier manner to eliminate error-invalid datasets, performs Gaussian fitting on a bathymetry distribution histogram generated by valid datasets to obtain a bathymetry distribution curve, fits parameters of the bathymetry distribution curve using a least squares manner, and then generates a bathymetry value of a target region.

However, the above achievements do not fully utilize inherent spectral characteristics of a water body, and this deficiency may lead to increased error in inverted bathymetry.

### SUMMARY

In view of the above problems, the present disclosure provides a method for multispectral remote sensing stochastic optimal ratio-logarithmic bathymetry inversion.

The present disclosure adopts the following technical solution:

A method for multispectral remote sensing stochastic optimal ratio-logarithmic bathymetry inversion, comprising:

S1: since a water body signal is generally less than 5%, constructing an atmospheric coupled radiometric calibration correction model by comprehensively considering influences of a solar spectrum, an upward total scattering, a solar zenith angle, a total global transmittance, a direct irradiance, and a total spherical albedo to correct an atmospheric reflectance and a water surface reflectance, as shown in formula (1):

$$ρ = {( {( {x}_{a} \cdot ( {DN}_{i} \cdot {Gain}_{i} + {Bias}_{i} ) - {x}_{b} )}^{- 1} + {x}_{c} )}^{- 1} ; \qquad ( 1 )$$

wherein i denotes an i-th band; DNᵢ denotes a gray value of the i-th band; Gainᵢ denotes an absolute calibration gain value of the i-th band; Biasᵢ denotes an offset value of the i-th band; ρ denotes a surface true reflectance after atmospheric coupled radiometric calibration correction; xₐ, x_{b}, and x_{c} denote atmospheric correction coefficients calculated by the atmospheric coupled radiometric calibration correction model;

wherein the atmospheric correction coefficients xₐ, x_{b}, and x_{c} are obtained by formula (2):

$$\{ \begin{matrix}{x}_{a} = \frac{π * ( {S}_{b} ) * ( {S}_{eb} ) * ( {S}_{utott} )}{cos ( \frac{{Z}_{enith} * π}{180} ) * ( {T}_{s} ) * ( {S}_{dtott} )} \\ {x}_{b} = \frac{( {A}_{inr} ) * ( {S}_{dtott} )}{( {T}_{s} ) * ( {S}_{utott} )} \\ {x}_{c} = {S}_{ast}\end{matrix} ; \qquad ( 2 )$$

wherein S_{b} (funct filter) denotes a functional filter, S_{eb} (sol spect) denotes the solar spectrum, Sᵤₜₒₜₜ (upward total scattering) denotes the upward total scattering. Zₑₙᵢₜₕ denotes the solar zenith angle, Tₛ (total global transmittance) denotes the total global transmittance, S_{dtott} (downward total scattering) denotes a downward total scattering, Aᵢₙᵣ (direct irradiance) denotes the direct irradiance, and Sₐₛₜ (total spherical albedo) denotes the total spherical albedo;

S2: based on an overpass time of a satellite remote sensing image, constructing a divided difference interpolation tide height correction model to obtain an instantaneous tide height, and a tide height correction is performed using formula (3):

$${d}_{t} = {d}_{m} + ( {d}_{d} - {d}_{H} ) ; \qquad ( 3 )$$

wherein dₜ denotes instantaneous bathymetric data, dₘ denotes measured bathymetric data, d_{d} denotes a difference between a mean sea level and a tidal datum, and d_{H} denotes a tide height value; wherein d_{H}(x) is obtained by a divided difference interpolation transformation:

$${d}_{H} ( x ) = f [ {x}_{0} ] + ( x - {x}_{0} ) f [ {x}_{0} , {x}_{1} ] + ( x , {x}_{0} ) ( x - {x}_{1} ) \cdot f [ {x}_{0} , {x}_{1} , {x}_{2} ] + … + ( x - {x}_{0} ) ( x - {x}_{1} ) … ( x - {x}_{n - 1} ) f [ {x}_{0} , {x}_{1} , … {x}_{n} ] ;$$

wherein x denotes an overpass time

$$[ \frac{n}{2} ]$$

of the satellite remote sensing image, x₀ denotes a 0-th whole hour moment earlier than the overpass time of the satellite remote sensing image, x₁ denotes a first whole hour moment of the overpass time of the satellite remote sensing image, x₂ denotes a second whole hour moment of the overpass time of the satellite remote sensing image, xₙ₋₁ denotes an (n−1)-th moment later than the overpass time of the satellite remote sensing image, and xₙ, denotes an n-th moment later than the overpass time of the satellite remote sensing image; tide height data ƒ[x₀, x₁, . . . xₙ], i=0,1, . . . , n corresponding to a plurality of known whole hour moments are known; to obtain d_{H}(x), divided differences of various orders at the plurality of known whole hour moments of ƒ(x) are calculated, and the divided differences are as shown in the following table.

| | | First-order | Second-order | Third-order | N-th order |
|---|---|---|---|---|---|
| | | divided | divided | divided | divided |
| xᵢ | f(xᵢ) | difference | difference | difference | difference |
| x₁ | f(x₁) | | | | |
| x₂ | f(x₂) | f[x₀, x₁] | | | |
| x₃ | f(x₃) | f[x₁, x₂] | f[x₀, x₁ x₂] | | |
| x₄ | f(x₄) | f[x₂, x₃] | f[x₁, x₂, x₃] | f[x₀, x₁, x₂, x₃] | |
| . . . | | | | | |
| xₙ | f(xₙ) | f[xₙ₋₁, xₙ] | f[xₙ₋₂, xₙ₋₁, xₙ] | f[xₙ₋₃, xₙ₋₂, xₙ₋₁, xₙ] | f[x₀, x₁, . . . xₙ] |

S3: when extracting water body information, since a near-infrared band pixel is contaminated by ground object information, by combining a characteristic of a low surface shortwave infrared band reflectance, constructing an FNDWI normalized difference water index to accurately extract a water body range:

$$FNDWI = \frac{{R}_{rs green} - {R}_{rs SWIR}}{{R}_{rs green} + {R}_{rs SWIR}} ; \qquad ( 4 )$$

wherein R_{rs geen} and R_{rs SWIR} denote a green band reflectance and a shortwave infrared band reflectance in the satellite remote sensing image, respectively; determining whether a pixel is a water body based on a threshold 0, in response to determining that a pixel where the FNDWI is greater than the threshold 0, classifying the pixel as the water body, and then performing a land-water mask;

S4: constructing a data set based on an image and bathymetric data at the overpass time of the satellite remote sensing image:

$$D = \{ ( {x}_{1} , {y}_{1} ) , ( {x}_{2} , {y}_{2} ) , … , ( {x}_{i} , {y}_{i} ) \} , i = 1 , 2 , … , N ;$$

wherein xᵢ=[Rᵣₛ(blue)ᵢ, Rᵣₛ(green)ᵢ] denotes an i-th input data feature; yᵢ denotes a target region value corresponding to a remote sensing data feature, i.e., measured bathymetric data after the tide height correction;

S5: constructing an optimal ratio-logarithmic model for bathymetry inversion; optimizing the optimal ratio-logarithmic model for bathymetry inversion by a random algorithm;

S5-1: constructing a ratio-logarithmic model:

$$Z = A \cdot ln \frac{L ( {λ}_{i} )}{L ( {λ}_{j} )} - B ; \qquad ( 5 )$$

wherein A is a scale adjustment constant of a ratio for bathymetry, λᵢ is the green band, λⱼ is a blue band, L(λᵢ) is a water body reflectance at a water depth Z for the green band, L(λⱼ) is a water body reflectance at the water depth Z for the blue band, and B is an offset relative to a water depth at a 0 m water level;

S5-2: constructing a stochastic optimal value selection model to find an optimal model parameter data set, and obtaining values of A and B with a minimum error:

$$T ( x ) = P ( x ) \cdot S ( x ) + ( 1 - P ( x ) ) \cdot ( e ( x ) + T ( x ) ) ; \qquad ( 6 )$$

$$\begin{matrix}Further : & \\ T ( x ) = S ( x ) + \frac{1 - P ( x )}{P ( x )} \cdot e ( x ) ; & ( 7 )\end{matrix}$$

wherein x is a bathymetric value of a training set; P(x)>0 is a probability of obtaining a minimum difference between A and B; T(x) is a time required to find the minimum difference; and S(x) and e(x) are times required to find a maximum or the minimum difference between A and B;

S5-3: constructing an extreme gradient boosting manner to optimize model parameters; based on the dataset

$$D = {( {x}_{i} , {y}_{i} )}_{i = 1}^{N}$$

in S5-2, optimizing the model parameters, wherein xᵢ=[Rᵣₛ(blue)ᵢ, Rᵣₛ(green)ᵢ] in the dataset represents an i-th input data feature; and yᵢ represents corrected bathymetric data of the target region corresponding to the remote sensing data feature, a specific formula for optimizing the model parameters is shown in (8):

$$G ( ∅ ) = {\sum }_{i = 1}^{N} f ( {Z}_{i} , {\hat{Z}}_{i} ) + {\sum }_{k = 1}^{υ} Ω ( {V}_{k} ) ; \qquad ( 8 )$$

wherein Zᵢ is a predicted bathymetry value of the ratio-logarithmic model; ƒ is a loss function, which is usually a mean squared error; and Ω is a regularization term for controlling a complexity of the ratio-logarithmic model;

for each tree Ω(Vₖ), there is:

$$Ω ( {V}_{k} ) = γ \cdot U + \frac{1}{2} θ \cdot {\sum }_{j = 1}^{U} {ω}_{j}^{2} ; \qquad ( 9 )$$

wherein U is a count of leaf nodes of the tree; ωⱼ is a weight of each leaf node; and γ and θ are hyperparameters for controlling a complexity of the ratio-logarithmic model; gradient boosting lies in adding a new tree each time to fit a residual of a current ratio-logarithmic model; wherein an output of the new tree is a fit to the residual, thereby updating the ratio-logarithmic model;

$${W}_{i} = {Z}_{i} - {\hat{Z}}_{i}^{( U )} . \qquad ( 10 )$$

Compared with the prior art, the present disclosure has significant improvements in that:
1. Given that a water body signal is usually lower than 5%, the present disclosure constructs an atmospheric coupled radiometric calibration correction model by comprehensively considering influences of a solar spectrum, an upward total scattering, a solar zenith angle, a total global transmittance, a direct irradiance, and a total spherical albedo to correct an atmospheric reflectance and a water surface reflectance:
2. The divided difference interpolation tide height correction model constructed in the present disclosure can achieve tide height calculation at a transit moment of a satellite remote sensing image by using more than two types of data;
3. Given that a near-infrared band pixel may be contaminated by ground object information, and in combination with a characteristic of a low surface shortwave infrared band reflectance, the present disclosure constructs an FNDWI normalized difference water index to extract a water body range;
4. The ratio-logarithmic model provided in the present disclosure utilizes characteristics of underwater propagation attenuation ratios of a blue band and a green band, which can better invert bathymetry, and is insensitive to a substrate at the same time;
5. Given that a problem of a large data volume of a dataset, the random algorithm model provided in the present disclosure extracts a sub-dataset, thereby reducing time complexity of data extraction;
6. Given the problem of difficulty in inversion of model parameters, the extreme gradient boosting manner provided in the present disclosure updates and iteratively optimizes the model parameters.

### BRIEF DESCRIPTION OF THE DRAWINGS

FIG. 1 is a flowchart illustrating an exemplary process for multispectral remote sensing stochastic optimal ratio-logarithmic bathymetry inversion according to some embodiments of the present disclosure;

FIG. 2 is a schematic diagram illustrating a location of an experimental region according to some embodiments of the present disclosure;

FIG. 3 is a schematic diagram illustrating Landsat-9 satellite remote sensing image data according to some embodiments of the present disclosure;

FIG. 4 is a schematic diagram illustrating bathymetric data according to some embodiments of the present disclosure;

FIG. 5 is a flowchart illustrating an exemplary process of tide height correction according to some embodiments of the present disclosure;

FIG. 6 is a schematic diagram illustrating a scatter plot of bathymetry inverted by a classical model and true bathymetry according to some embodiments of the present disclosure; and

FIG. 7 is a schematic diagram illustrating a scatter plot of inverted bathymetry and true bathymetry according to some embodiments of the present disclosure.

### DETAILED DESCRIPTION

To make the objectives, technical solutions, and advantages of the present disclosure clearer, the following further describes the present disclosure in detail with reference to the accompanying drawings. Based on the embodiments in the present disclosure, all other embodiments obtained by a person of ordinary skill in the art without creative efforts shall fall within the protection scope of the present disclosure.

The operations involved in the present disclosure are all executed by a processor. The processor may be mounted on a satellite data processing terminal, a professional geographic information processing device, a computer device with data processing functions, or the like.

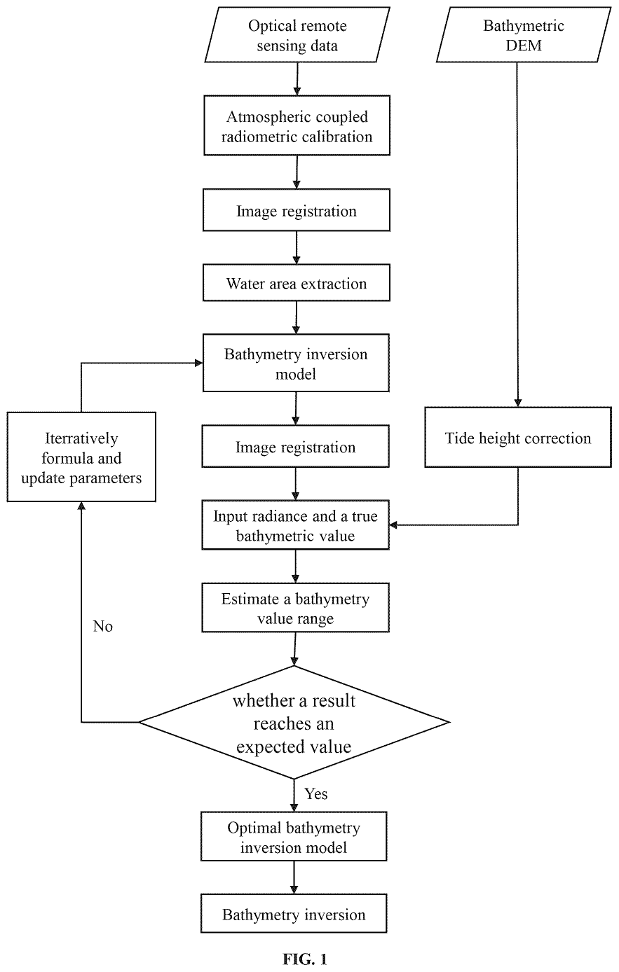

FIG. 1 is a flowchart illustrating an exemplary process for multispectral remote sensing stochastic optimal ratio-logarithmic bathymetry inversion according to some embodiments of the present disclosure.

In some embodiments, the method may be executed by a processor. The processor may include one or more sub-processing devices (e.g., a single-core processing device or a multi-core multi-chip processing device). Merely by way of example, the processor may include a central processing unit (CPU), an application-specific integrated circuit (ASIC), a microprocessor, or any combination thereof.

In some embodiments, the processor first corrects optical remote sensing data (including a satellite remote sensing image) through atmospheric coupled radiometric calibration (i.e., an atmospheric coupled radiometric calibration correction model), performs image (i.e., the satellite remote sensing image) registration, then performs water area extraction (i.e., land-water mask processing), and inputs an extraction result into a bathymetry inversion model (i.e., a ratio-logarithmic model). Simultaneously, the processor performs tide height correction in combination with a bathymetric digital elevation model (DEM). The processor transmits a true bathymetric value after the tide height correction (i.e., a measured bathymetric data) and input radiance (which may be converted into a surface true reflectance) together into the bathymetric inversion model. After the model estimates a bathymetry value range, the processor determines whether a result reaches an expected value. If the result does not reach the expected value, the processor updates parameters through an iterative formula and inputs the parameters into the model for calculation again. If the result reaches the expected value, the processor determines an optimal bathymetry inversion model (i.e., an optimal ratio-logarithmic model for bathymetry inversion) and finally performs bathymetry inversion.

The expected value refers to a preset inversion accuracy target value (e.g., a maximum allowable error, a target accuracy rate, or the like).

In some embodiments, the method for multispectral remote sensing stochastic optimal ratio-logarithmic bathymetry inversion may include the following operations S1 to S5.

S1: since a water body signal is generally less than 5%, constructing an atmospheric coupled radiometric calibration correction model by comprehensively considering influences of a solar spectrum, an upward total scattering, a solar zenith angle, a total global transmittance, a direct irradiance, and a total spherical albedo to correct an atmospheric reflectance and a water surface reflectance to obtain a surface true reflectance.

A signal received by a remote sensing sensor of a satellite includes not only a surface but also interference items such as an atmospheric reflectance and a water surface reflectance. Therefore, the interference items (i.e., the atmospheric reflectance and the water surface reflectance) need to be eliminated by constructing the atmospheric coupled radiometric calibration correction model to finally obtain the surface true reflectance.

A calculation manner of the surface true reflectance is shown in formula (1):

$$ρ = {( {( {x}_{a} \cdot ( {DN}_{i} \cdot {Gain}_{i} + {Bias}_{i} ) - {x}_{b} )}^{- 1} + {x}_{c} )}^{- 1} ; \qquad ( 1 )$$

In the formula (1), i denotes a ith band; DNᵢ denotes a gray value of the ith band; Gainᵢ denotes an absolute calibration gain value of the ith band; Biasᵢ denotes an offset value of the ith band; ρ denotes a surface true reflectance after atmospheric coupled radiometric calibration correction; xₐ, x_{b}, and x_{c} denotes atmospheric correction coefficients calculated by the model (i.e., the atmospheric coupled radiometric calibration correction model).

In some embodiments, bands of the satellite remote sensing image may include a blue band, a green band, a shortwave infrared band, or the like.

The coefficients xₐ, x_{b}, and x_{c} may be obtained by formula (2):

$$\{ \begin{matrix}{x}_{a} = \frac{π * ( {S}_{b} ) * ( {S}_{eb} ) * ( {S}_{utott} )}{cos ( \frac{{Z}_{enith} * π}{180} ) * ( {T}_{s} ) * ( {S}_{dtott} )} \\ {x}_{b} = \frac{( {A}_{inr} ) * ( {S}_{dtott} )}{( {T}_{s} ) * ( {S}_{utott} )} \\ {x}_{c} = {S}_{ast}\end{matrix} ; \qquad ( 2 )$$

In the formula (2), S_{b} (funct filter) denotes a functional filter, S_{eb} (sol spect) denotes the solar spectrum, Sᵤₜₒₜₜ (upward total scattering) denotes the upward total scattering, Zₑₙᵢₜₕ denotes the solar zenith angle, Tₛ (total global transmittance) denotes the total global transmittance, S_{dtott} (downward total scattering) denotes a downward total scattering, Aᵢₙᵣ (direct irradiance) denotes the direct irradiance, and Sₐₛₜ (total spherical albedo) denotes the total spherical albedo (i.e., the total spherical albedo described above).

The water body signal refers to a reflected signal of incident light by a water body. For example, the water body signal may be a reflected signal of a seawater blue band observed by a satellite.

The atmospheric coupled radiometric calibration correction model refers to a model that converts a satellite gray value into the surface true reflectance through absolute radiometric calibration and atmospheric effect correction to eliminate atmospheric or water surface interference.

In some embodiments, the gray value may be directly read from a corresponding band pixel of the satellite remote sensing image.

In some embodiments, the absolute calibration gain value and the offset value may be obtained from a metadata file (MTL) of the satellite remote sensing image.

In some embodiments, the functional filter, the solar spectrum, the upward total scattering, the downward total scattering, the solar zenith angle, the total global transmittance, the direct irradiance, the total spherical albedo, or the like may be obtained from supporting observation data of the satellite remote sensing image, a prior model, or a standard database.

S2: based on an overpass time of a satellite remote sensing image, constructing a divided difference interpolation tide height correction model to obtain an instantaneous tide height, and a tide height correction is performed by using formula (3):

$${d}_{t} = {d}_{m} + ( {d}_{d} - {d}_{H} ) ; \qquad ( 3 )$$

In the formula (3), dₜ denotes instantaneous bathymetric data, dₘ denotes measured bathymetric data, d_{d} denotes a difference between a mean sea level and a tidal datum, and d_{H} denotes a tide height value (i.e., the instantaneous tide height). The d_{H}(x) is obtained by a divided difference interpolation transformation:

$${d}_{H} ( x ) = f [ {x}_{0} ] + ( x - {x}_{0} ) f [ {x}_{0} , {x}_{1} ] + ( x , {x}_{0} ) ( x - {x}_{1} ) \cdot f [ {x}_{0} , {x}_{1} , {x}_{2} ) + … + ( x - {x}_{0} ) ( x - {x}_{1} ) … ( x - {x}_{n - 1} ) f [ {x}_{0} , {x}_{1} , … {x}_{n} ] ; \qquad ( 11 )$$

In the above formula (11), x denotes an overpass time

$$[ \frac{n}{2} ]$$

of the satellite remote sensing image, x₀ denotes a 0th whole hour moment earlier than the overpass rtime of the satellite remote sensing image, x₁ denotes a first whole hour moment of the overpass time of the satellite remote sensing image, x₂ denotes a second whole hour moment of the overpass time of the satellite remote sensing image, xₙ₋₁ denotes an n−1th moment later than the overpass time of the satellite remote sensing image, and xₙ denotes an nth moment later than the overpass time of the satellite remote sensing image, tide height data ƒ(x_{f}), i=0,1, . . . n corresponding to a plurality of known whole hour moments xᵢ denotes a known quantity, and to obtain d_{H}(x), divided differences of various orders at the plurality of known whole hour moments of ƒ(x) are calculated, and the divided differences are as shown in the following table:

| | | First-order | Second-order | Third-order | Nth-order |
|---|---|---|---|---|---|
| | | divided | divided | divided | divided |
| xᵢ | f(xᵢ) | difference | difference | difference | difference |
| x₁ | f(x₁) | | | | |
| x₂ | f(x₂) | f[x₀, x₁] | | | |
| x₃ | f(x₃) | f[x₁, x₂] | f[x₀, x₁ x₂] | | |
| x₄ | f(x₄) | f[x₂, x₃] | f[x₁, x₂, x₃] | f[x₀, x₁, x₂, x₃] | |
| . . . | | | | | |
| xₙ | f(xₙ) | f[xₙ₋₁, xₙ] | f[xₙ₋₂, xₙ₋₁, xₙ] | f[xₙ₋₃, xₙ₋₂, xₙ₋₁, xₙ] | f[x₀, x₁, . . . xₙ] |

In some embodiments, the processor may obtain an overpass time of the satellite remote sensing image from the metadata file of the satellite remote sensing image.

The divided difference interpolation tide height correction model refers to a model formed by combining a divided difference interpolation transformation and a correction formula, i.e., the model formed by combining the above formula (3) and formula (11). In some embodiments, based on the plurality of known whole hour moments xᵢ and corresponding tide height values ƒ(xᵢ), the divided difference interpolation tide height correction model calculates the tide height value d_{H} at the overpass time x of the satellite remote sensing image through divided difference interpolation of formula (3). The divided difference interpolation tide height correction model then corrects the measured bathymetric data dₘ in combination with correction formula (11), and finally outputs the instantaneous bathymetric data dₜ matching the satellite remote sensing image.

The instantaneous tide height d_{H} refers to an instantaneous height of a sea surface relative to the tidal datum.

The instantaneous bathymetric data dₜ refers to instantaneous bathymetry matching the satellite remote sensing image.

The measured bathymetric data dₘ refers to measured bathymetry based on the tidal datum. In some embodiments, the measured bathymetric data may be obtained based on a known nautical chart.

In some embodiments, the difference d_{d} between the mean sea level and the tidal datum may be obtained by the processor based on datum information of the known nautical chart.

S3: When extracting water body information, since a near-infrared band pixel may be contaminated by ground object information, by combining a characteristic of a low surface shortwave infrared band reflectance, constructing an FNDWI normalized difference water index to accurately extract a water body range:

$$FNDWI = \frac{{R}_{rs green} - {R}_{rs SWIR}}{{R}_{rs green} + {R}_{rs SWIR}} ; \qquad ( 4 )$$

In the formula (4), R_{rs green} and R_{rs SWIR} denote a green band reflectance and a shortwave infrared band reflectance in the satellite remote sensing image, respectively; whether a pixel is a water body based on a threshold 0 is determined, in response to determining that a pixel where the FNDWI is greater than the threshold 0, the pixel is classified as the water body, and then a land-water mask is performed.

The water body information refers to pixel data of a water body in the satellite remote sensing image, used to reflect a characteristic such as a position and a range of the water body. For example, a pixel set corresponding to a river in the satellite remote sensing image is the water body information of a region of the river.

The FNDWI normalized difference water index refers to an index constructed using the green band reflectance and the shortwave infrared band reflectance, used to distinguish the water body from a non-water body.

The water body range refers to a pixel set belonging to the water body in the satellite remote sensing image.

In some embodiments, for each pixel in the satellite remote sensing image, the processor calculates the FNDWI normalized difference water index for the pixel based on the surface true reflectance of the green band and the shortwave infrared band of the pixel. If the FNDWI normalized difference water index of the pixel is greater than the threshold 0, the processor determines that the pixel is the water body. Through the above process, all pixels with FNDWI normalized difference water indices greater than the threshold 0 are screened out. A set of the pixels is the water body range, a land-water mask processing is then performed based on the water body range. More descriptions regarding the land-water mask processing may be found in the following content and related descriptions.

S4: constructing a data set based on an image (i.e., the satellite remote sensing image) and bathymetric data at a satellite overpass time (i.e., the overpass time of the satellite remote sensing image):

$$D = \{ ( {x}_{1} , {y}_{1} ) , ( {x}_{2} , {y}_{2} ) , … , ( {x}_{i} , {y}_{i} ) \} , i = 1 , 2 , … , N ;$$

In the above formula, xᵢ=[Rᵣₛ(blue)ᵢ, Rᵣₛ(green)ᵢ] denotes an i-th input data feature, Rᵣₛ(blue) denotes the blue band reflectance, Rᵣₛ(blue)ᵢ denotes the blue band reflectance in the i-th input data feature, Rᵣₛ(green) denotes the same as R_{rs green} in the formula (4) and denotes the green band reflectance, Rᵣₛ(green)ᵢ denotes the green band reflectance in the i-th input data feature, yᵢ denotes a target region value corresponding to the i-th input data feature, i.e., the measured bathymetric data after tide height correction. D denotes the dataset.

More descriptions regarding the measured bathymetric data may be found in the preceding content and related descriptions.

The dataset D refers to a sample set containing data features of the target region and corresponding measured bathymetric data.

A data feature (also referred to as the remote sensing data feature) refers to an input information item in the dataset, which here refers to the reflectance of the blue band Rᵣₛ(blue) and the reflectance of the green band Rᵣₛ(green) in the satellite remote sensing image, the data feature may be obtained through the operation S1.

The target region refers to a region in the satellite remote sensing image where bathymetry inversion needs to be performed. In some embodiments, the target region may be delineated manually.

S5: constructing an optimal ratio-logarithmic model for bathymetry inversion; optimizing the optimal ratio-logarithmic model for bathymetry inversion by a random algorithm.

The optimal ratio-logarithmic model for bathymetry inversion refers to a model established for bathymetry inversion through a ratio-logarithmic of water body reflectances of the blue band and the green band.

In some embodiments, parameters of the optimal ratio-logarithmic model for bathymetry inversion may include a scale adjustment constant A and an offset B.

The random algorithm refers to an algorithm that optimizes model parameters by introducing randomness (e.g., random sampling, random search). For example, the random algorithm may include a stochastic optimal value selection algorithm, a random sampling algorithm, a random search algorithm, or the like.

In some embodiments, operation S5 includes the following sub-operations:

S5-1: constructing a ratio-logarithmic model:

$$Z = A \cdot ln \frac{L ( {λ}_{i} )}{L ( {λ}_{j} )} - B ; \qquad ( 5 )$$

In the formula (5), A is a scale adjustment constant of a ratio for bathymetry, λᵢ is the green band (i.e., the green band), λⱼ is the blue band (i.e., the blue band), L(λᵢ) is a water body reflectance at a water depth Z for the green band, L(λⱼ) is a water body reflectance at the water depth Z for the blue band, and B is an offset relative to a water depth at a 0 m water level. L(λᵢ) and L(λⱼ) are the surface true reflectances and are obtained in operation S1.

The scale adjustment constant refers to a scaling coefficient between a ratio-logarithmic of reflectance and actual bathymetry. For example, if a value of the scale adjustment constant is 2, then for every increase of 1 in the ratio-logarithmic of reflectance, a corresponding actual bathymetry increases by 2 meters. In some embodiments, the processor may determine a specific numerical value of the scale adjustment constant through fitting analysis of the measured bathymetric data and corresponding ratio-logarithms of reflectance.

The water body reflectance refers to a scattering reflectance of water body interior to a band (e.g., the green band, the blue band) at the water depth Z. The water body reflectance is the surface true reflectance at the water depth Z and may be obtained through operation S1.

The offset relative to a water depth at a 0 m water level refers to a correction constant in the ratio-logarithmic model for calibrating a 0 m bathymetry datum, and is used to offset a deviation between a theoretical value and an actual observed value of a ratio-logarithmic of reflectance when bathymetry is 0 m. In some embodiments, the offset may be determined by the processor through fitting of the ratio-logarithmic model with the measured bathymetric data, in combination with a measured value of a ratio-logarithmic of reflectance corresponding to a water depth of 0 m (a water surface).

S5-2: constructing a stochastic optimal value selection model to find an optimal model parameter data set, and obtaining values of A and B with a minimum error:

$$T ( x ) = P ( x ) \cdot S ( x ) + ( 1 - P ( x ) ) \cdot ( e ( x ) + T ( x ) ) ; \qquad ( 6 )$$

$$Further :$$

$$T ( x ) = S ( x ) + \frac{1 - P ( x}{P ( x )} \cdot e ( x ) ; \qquad ( 7 )$$

In the formula (6), x is a bathymetric data of the training set (the x herein is different from the x in operation S2), P(x)>0 is a probability of obtaining a minimum difference between A and B, T(x) is a time required to find the minimum difference, and S(x) and e(x) are times required to find a maximum or a minimum difference between A and B. P(x) is a probability corresponding to the bathymetric data x of the training set.

In some embodiments, the processor first generates a plurality of groups of A and B parameter combinations through the random algorithm for optimal value selection, and preferentially screens out candidate combinations with a small difference between the parameter A and the parameter B (using the probability corresponding to P(x) as a screening basis). The processor then substitutes the candidate combinations into the ratio-logarithmic model (formula (5)), calculates predicted bathymetry values of the ratio-logarithmic model in combination with the reflectances of the blue band and the green band of the training set, and compares the predicted bathymetry values with water depth values of the measured bathymetric data after the tide height correction in the training set to determine errors. The processor finally selects, from the candidate combinations, an A and B combination with a minimum error between the predicted bathymetry values and the water depth values of the bathymetric data, and uses the A and B combination as the optimal model parameter data set.

The stochastic optimal value selection model refers to a model that screens out solutions satisfying an optimal condition (e.g., a maximum value or a minimum value) of an objective function through a random sampling manner.

S5-3: constructing an extreme gradient boosting manner to optimize model parameters.

Based on the dataset

$$D = {( {x}_{i} , {y}_{i} )}_{i = 1}^{N}$$

in S5-2 (i.e., D=((x₁, y₁), (x₂, y₂), . . . , (xᵢ, yᵢ), . . . , i=1,2, . . . , N), xᵢ=[Rᵣₛ(blue)ᵢ, Rᵣₛ(green)ᵢ] in the dataset represents an i-th input data feature; and yᵢ represents a corrected bathymetric value of the target region corresponding to the remote sensing data feature (i.e., a target region value corresponding to the i-th input data feature), a specific formula for optimizing the model parameters is shown in (8):

$$G ( ∅ ) = {\sum }_{i = 1}^{N} f ( {Z}_{i} , {\hat{Z}}_{i} ) + {\sum }_{k = 1}^{U} Ω ( {V}_{k} ) ; \qquad ( 8 )$$

In the formula (8), Zᵢ is a predicted bathymetry value of the ratio-logarithmic model; ƒ is a loss function (the ƒ herein is different from the ƒ in operation S2), which is usually a mean squared error; Ω is a regularization term for controlling a complexity of the ratio-logarithmic model;

In the formula (8), G(Ø) is an objective function of the extreme gradient boosting manner, N is a sample count of a sample dataset, Zᵢ is a predicted bathymetry value for an i-th sample (i.e., an i-th group of data features) by an extreme gradient boosting model constructed by the extreme gradient boosting manner, \hat{Z}ᵢ is a corrected bathymetric value of measured bathymetric data of the i-th sample (corresponding to yᵢ in the dataset D); U is a count of trees in the extreme gradient boosting manner, Ω(Vₖ) is a regularization term of a k-th tree for controlling complexity of the extreme gradient boosting model; Vₖ is a structural parameter of the k-th tree, and k refers to a serial number of each tree.

For each tree Ω(Vₖ), then:

$$Ω ( {V}_{k} ) = γ \cdot U + \frac{1}{2} θ \cdot {\sum }_{i = 1}^{U} {ω}_{j}^{2} ; \qquad ( 9 )$$

in the formula (9), U is a count of leaf nodes of the tree (the U herein is different from the U in the formula (8)), ωⱼ is a weight of a j-th leaf node, and γ and θ are hyperparameters for controlling complexity of the model; j is a serial number of a leaf node of the tree. Gradient boosting lies in adding a new tree each time to fit a residual of a current model. An output of the new tree is a fit to the residual, thereby updating the model;

$${W}_{i} = {Z}_{i} - {\hat{Z}}_{i}^{( U )} . \qquad ( 10 )$$

In the formula (10), Wᵢ is a residual corresponding to the i-th input data feature.

The extreme gradient boosting manner refers to an ensemble learning algorithm based on decision trees, which iteratively adds new trees to fit model residuals, while controlling complexity with regularization to improve model accuracy. The extreme gradient boosting model refers to a model obtained through training by the extreme gradient boosting manner.

The residual refers to a difference between the predicted bathymetry value of the extreme gradient boosting model and the corrected bathymetry value, and the residual is used to guide a fitting direction of a new tree. In some embodiments, the residual may be obtained through the above formula (10).

FIG. 1 is a flowchart illustrating an exemplary process for multispectral remote sensing stochastic optimal ratio-logarithmic bathymetry inversion according to some embodiments of the present disclosure.

With reference to FIG. 1, a flow of the following embodiments is described.

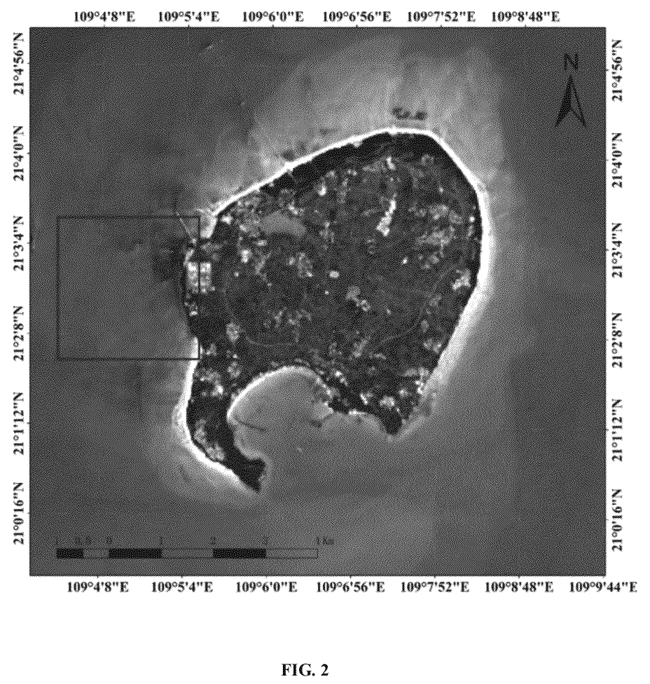

S11: FIG. 2 is a schematic diagram illustrating a location of an experimental region according to some embodiments of the present disclosure. With reference to FIG. 2, an experimental region is located in a coastal area on a west side of Weizhou Island, Beihai City, Guangxi Zhuang Autonomous Region, with a latitude range of 20°03′N−20°01′N and a longitude range of 109°03′E-109°05′E.

S12: data and preprocessing.

S12-1: image data and preprocessing.

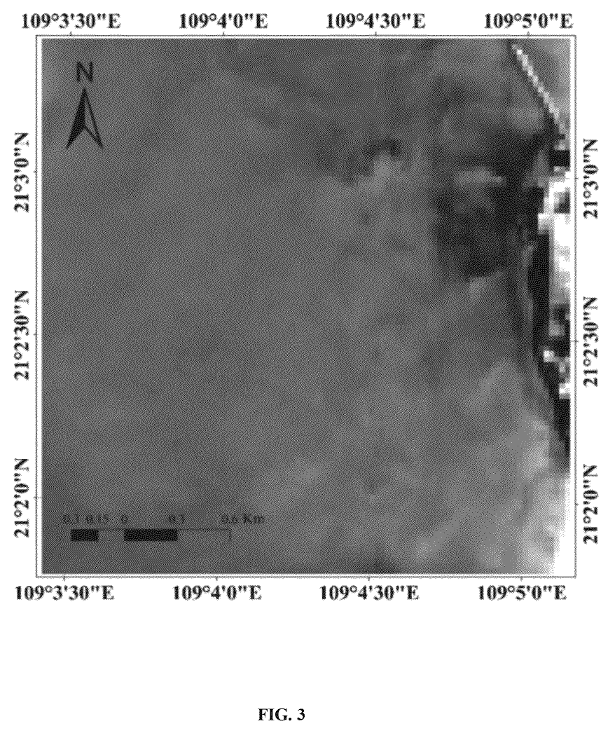

FIG. 3 is a schematic diagram illustrating a Landsat-9 satellite remote sensing image data according to some embodiments of the present disclosure. With reference to FIG. 3, an image used for the experimental region is a Landsat-9 remote sensing image, a product type is Collection 2 Level 1 (parameters are shown in Table 1), an image shooting time is 3:10 (UTC) on Apr. 9, 2022, and bands 1-7 and band 10 are used (parameters are shown in Table 2).

TABLE 1
Landsat 9 satellite orbit parameters

| Parameter | Index | |
|---|---|---|
| Orbit Type | Sun-Synchronous Regressive Orbit | |
| Orbit Altitude | 705 | km |
| Orbit Inclination | 98.2 | |
| Descending Node Local Time | 10:40 AM | |
| Regression Cycle | 16 | d |
| Swath Width | 185 | km |
| Design Life | 5 | Years |

TABLE 2
Landsat 9 satellite payload technical indices

| | | | Spatial |
|---|---|---|---|
| | | | Resolution |
| Detector | Spectrum | Band Range (μm) | (m) |
| Operational Land Imager | 1-Coastal Band | 0.43~0.45 | |
| (OLI-2) | 2-Blue Band | 0.45~0.51 | |
| | 3-Green Band | 0.53~0.59 | |
| | 4-Red Band | 0.64~0.67 | 30 |
| | 5-Near-Infrared Band | 0.85~0.88 | |
| | 6-Mid-Infrared 1 | 1.57~1.65 | |
| | 7-Mid-Infrared 2 | 2.11~2.29 | |
| | 8-Panchromatic Band | 0.50~0.68 | 15 |
| Thermal Infrared Sensor | 9-Cirrus Band | 1.36~1.38 | 30 |
| (TIRS-2) | 10-Thermal Infrared | 10.6~11.19 | 100 |
| | 1 | | |
| | 11-Thermal Infrared | 11.5~12.51 | |
| | 2 | | |

Based on the formulas (1) and (2), atmospheric coupled radiometric calibration correction is performed in an Interactive Data Language (IDL) environment, and a result is returned to ENVI. A processor reads calibration coefficients of each band, converts digital numbers (DN values) into radiance values, and saves a calibration result.

Based on the atmospheric coupled radiometric calibration correction model, the processor first needs to format and organize three coefficients xₐ, x_{b}, and x_{c} into numerical values, create an input text file, and then output the input text file. The input text file is saved as a txt file (named in.txt). The input text file is placed in a same directory as a model execution file (main.exe). In a command line mode, an instruction “mainout.txt” is input. The atmospheric coupled radiometric calibration correction model is invoked for calculation. An output result file out.txt is obtained.

The output file includes four parts. A first part lists input parameters; a second part provides components such as a direct radiation component, a scattering radiation component, and an environmental radiation component in atmospheric radiation transmission; a third part illustrates influences of various atmospheric components in an upward radiation transmission process and a downward radiation transmission process.

A fourth part of the output file includes three coefficient values (i.e., atmospheric correction coefficients xₐ, x_{b}, and x_{c}) required for atmospheric correction of a satellite remote sensing image.

The processor applies atmospheric correction coefficients of all bands of Landsat-9 to a radiance image by using IDL language. Atmospheric correction is completed. An IDL program is compiled and executed. A surface true radiance file is obtained.

S12-2: obtain bathymetry ENCs electronic nautical chart

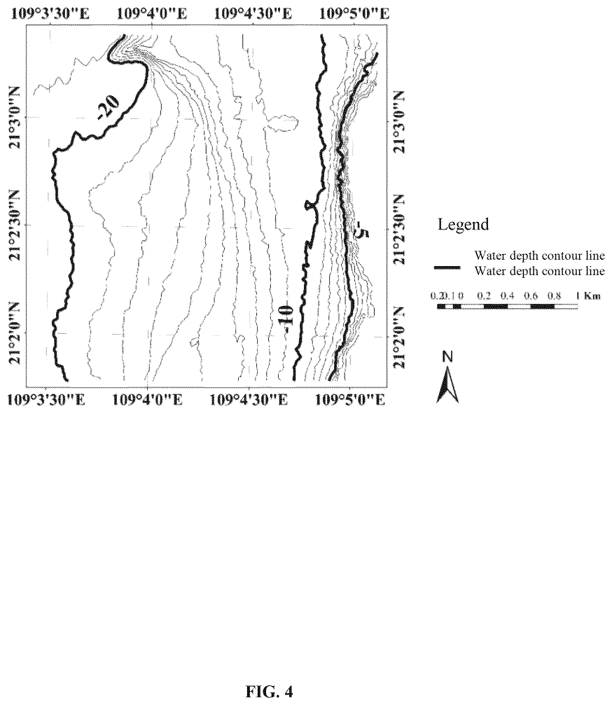

FIG. 4 is a schematic diagram illustrating bathymetric data according to some embodiments of the present disclosure. With reference to FIG. 4, bathymetric data of the experimental region of the present embodiment is obtained from a website https://www.gebco.net/(parameters are shown in Table 3). The bathymetric data is resampled to 30 meters by using ArcGis. The bathymetric data consistent with a size of the experimental region is cropped in ENVI.

TABLE 3
overview of DBMs dataset

| Dataset | GEBCO_2022 |
|---|---|
| Update Time | 2022 |
| Organization | The Nippon Foundation-GEBCO |
| Country | UK-Japan |
| Resolution | 15″ |
| Spatial Range | (179°59′52.5″E~179°59′52.5″W, |
| | 89°59′52.5″S~89°59′52.5″N) |
| Horizontal Datum | WGS84 MSL |
| Vertical Datum | |

S12-3: obtaining tide height data and correcting tide height.

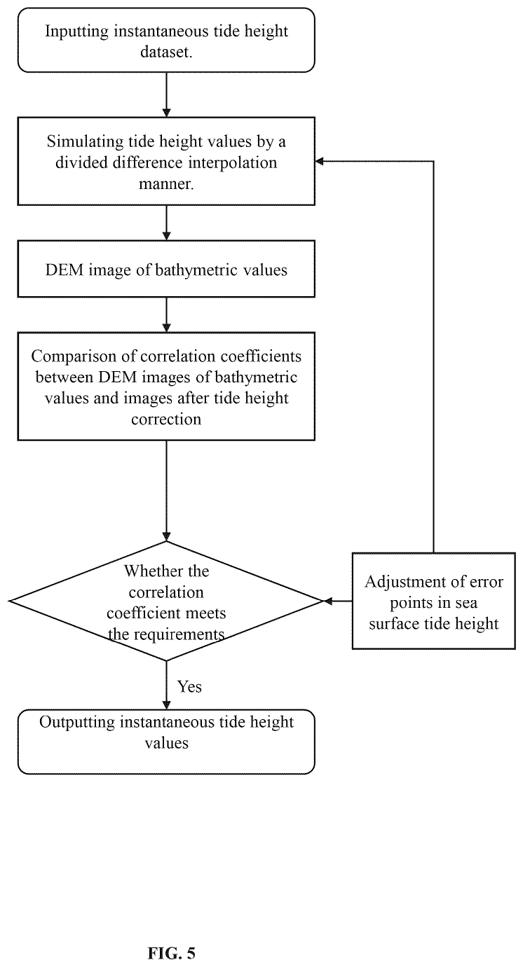

FIG. 5 is a flowchart illustrating an exemplary process of tide height correction according to some embodiments of the present disclosure. With reference to FIG. 5, a tide table of the experimental region of the present embodiment is obtained through a website. Based on the formula (3), the processor calculates instantaneous bathymetric data corresponding to each bathymetric point in a measured bathymetric data set according to an overpass time of the satellite remote sensing image of Landsat-9 by using a divided difference interpolation tide height correction model (partial parameters are shown in Table 4). After the tide height correction is completed, matching is performed with the dataset.

TABLE 4
partial training set bathymetric data points and bathymetry
at satellite remote sensing image transit moments

| Serial | Electronic Chart | Depth at Satellite Remote Sensing Image |
|---|---|---|
| Number | Bathymetry Depth (m) | Transit Moment (m) |
| 1 | −21.57 | −21.75 |
| 2 | −20.48 | −20.66 |
| 3 | −6.70 | −6.88 |
| 4 | −19.62 | −19.8 |
| 5 | −15.06 | −15.24 |
| 6 | −17.95 | −18.13 |
| 7 | −20.66 | −20.84 |
| 8 | −19.69 | −19.87 |
| 9 | −12.89 | −13.07 |
| 10 | −5.06 | −5.24 |

S13: Based on the formula (4), mask processing is performed on the satellite remote sensing image data. A determination of whether a pixel is a water body is made according to a threshold 0, i.e., FNDWI>0 indicates a water body. Land-water mask separation is then performed. After masking, a water body pixel value within the experimental region is 1, and a non-water body pixel value is 0.

S14: Based on the formula (5), a blue band and a green band of the Landsat-9 satellite remote sensing image corresponding to the image data points are selected as input feature spectral parameters. Initial data input is performed in an IDL environment. Measured bathymetric data of a target region (the experimental region) after tide height correction is used as secondary input data features, obtaining a dataset

$$D = {( {x}_{i} , {y}_{i} )}_{i = 1}^{N} . {x}_{i} = [ {{R}_{rs} ( blue )}_{i} , {{R}_{rs} ( green )}_{i} ]$$

represents the i-th input data feature, yᵢ represents a corrected bathymetric value of the target region corresponding to the remote sensing data feature (i.e., the target region value), i.e., the measured bathymetric data after tide height correction.

S14-1: Based on the formulas (6)-(7), a stochastic optimal value selection model is constructed to find an optimal model parameter data set, thereby determining values of A and B with a minimum error.

S14-2: Based on the stochastic optimal value selection model, an extreme gradient boosting manner is further constructed to optimize model parameters of the ratio-logarithmic model. Merely by way of example, the processor inputs the dataset into the ratio-logarithmic model after preliminary parameter optimization for training. After traversal, an optimal parameter combination for the ratio-logarithmic model is determined. Regularization is used to control complexity of the optimal ratio-logarithmic model for bathymetry inversion to prevent overfitting. Finally, an optimized optimal ratio-logarithmic model for bathymetry inversion that is able to be directly used for bathymetry inversion is obtained.

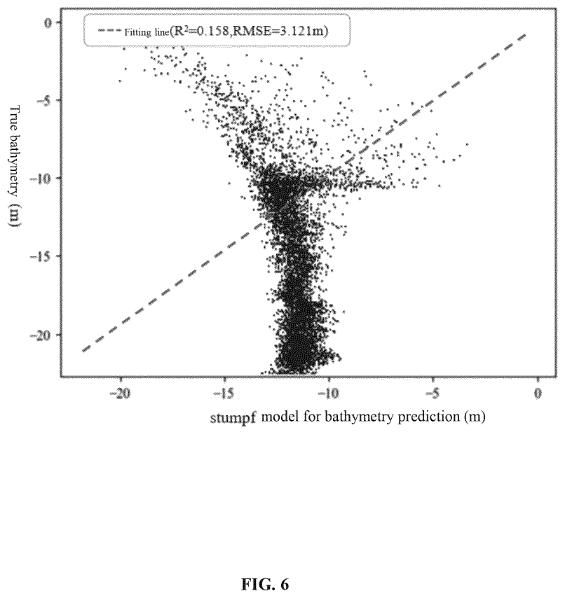

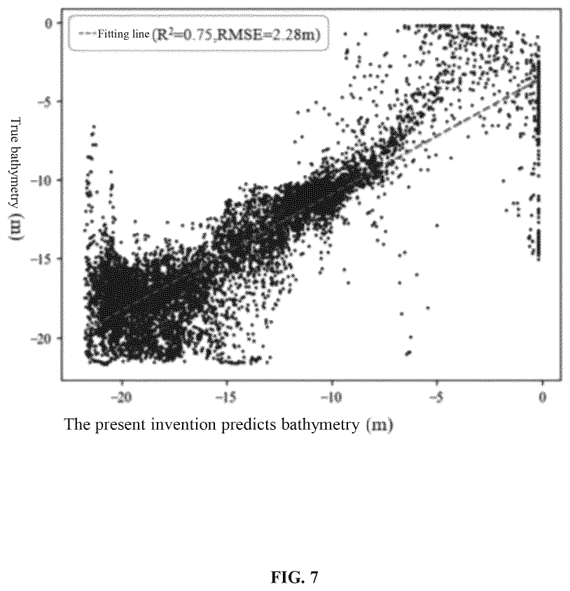

FIG. 6 is a schematic diagram illustrating a scatter plot of bathymetry inverted by a classical model and true bathymetry according to some embodiments of the present disclosure. FIG. 7 is a schematic diagram illustrating a scatter plot of inverted bathymetry and true bathymetry according to some embodiments of the present disclosure.

S15: With reference to FIG. 6 and FIG. 7, accuracy of the present disclosure is verified. The present disclosure conducted a bathymetry inversion experiment using a Stumpf model in the same region and with the same image data. As shown in FIG. 6 and FIG. 7, compared with the Stumpf model, the present model (i.e., the optimal ratio-logarithmic model for bathymetry inversion) shows an improvement of 0.592 in R² accuracy and an improvement of 0.841 m in RMSE.

In some embodiments of the present disclosure, an atmospheric, water surface, and tidal level correction model is constructed by integrating a plurality of factors, A water body is accurately extracted by combining the FNDWI normalized difference water index. Parameters of the ratio-logarithmic model are optimized by the stochastic optimal value selection model. Significant improvement in the bathymetry inversion effect is achieved. Compared with the Stumpf model, the optimal ratio-logarithmic model for bathymetry inversion shows an improvement of 0.592 in R² accuracy and an improvement of 0.841 m in RMSE for inverted bathymetry. The difficulty of bathymetry inversion under low water body signal conditions is effectively solved.

In some embodiments, operation S2 further includes: based on a submarine topography complexity, a tidal type, a tide height change rate of the target region, and a time offset between a nearest whole hour moment and the overpass time of the satellite remote sensing image, determining an optimal count of nodes for divided difference interpolation by querying a preset table.

The submarine topography complexity refers to an intensity of seafloor elevation variation within the target region. For example, the submarine topography complexity may be a standard deviation of bathymetric values per unit area within the target region, a slope change rate, or the like. More descriptions regarding the target region may be found in the foregoing description and related descriptions.

In some embodiments, the processor may calculate the submarine topography complexity based on existing historical nautical chart data of the target region (e.g., ENCs-electronic navigational charts) or publicly available low-resolution global seafloor topographic data (e.g., GEBCO-General Bathymetric Chart of the Oceans). The calculation may determine a standard deviation of bathymetric values per unit area within the target region, a slope change rate, or the like.

The tidal type refers to a pattern type of tidal rise and falls in the target region. For example, the tidal type may include a regular semidiurnal tide, a regular diurnal tide, a mixed tide (e.g., an irregular semidiurnal tide, a diurnal tide, etc.), or the like.

In some embodiments, the processor may determine the tidal type of the target region by querying a global tidal model database based on latitude and longitude coordinates of the target region.

The tide height change rate refers to an amplitude of tide height rise or fall per unit time before and after an overpass time of the satellite remote sensing image. The tide height change rate is used to reflect whether the tide is in a gentle period or a period of rapid change.

In some embodiments, the processor may extract tide height values at consecutive time points from a known tide table. The processor may calculate an average change rate between adjacent tide height points. The processor may use the average change rate as the tide height change rate. The known tide table may be official tidal forecast data released by marine hydrological observation agencies (e.g., maritime departments, ocean bureaus). The known tide table may be a tidal database formed by organizing historical tidal observation records, etc.

In some embodiments, the known tide table may include a time axis and corresponding tide height values. The time axis includes a plurality of whole hour moments.

A time offset between the nearest whole hour moment and the overpass time of the satellite remote sensing image refers to a time difference between an actual acquisition time of the satellite remote sensing image and the nearest whole hour moment.

In some embodiments, the processor may extract the actual acquisition time of the satellite remote sensing image from a remote sensing image data file. The processor may compare the actual acquisition time with whole hour moments in the time axis of the known tide table to calculate the time offset.

A node refers to an interpolation data point used in the divided difference interpolation calculation.

In some embodiments, the processor may obtain an optimal count of nodes for divided difference interpolation by querying a preset table based on the submarine topography complexity, the tidal type, the tide height change rate of the target region, and the time offset between the nearest whole hour moment and the overpass time of the satellite remote sensing image.

In some embodiments, the preset table may include a correspondence relationship among the submarine topography complexity, the tidal type, the tide height change rate, the time offset, and the optimal count of nodes.

In some embodiments, the optimal count of nodes is positively correlated with the submarine topography complexity. Greater seafloor undulation and more intense bathymetric variation cause bathymetric fluctuations induced by tidal changes to exhibit stronger nonlinear characteristics. Therefore, the divided difference interpolation process requires more nodes to capture nonlinear variation details of bathymetry with tidal changes, i.e., the optimal count of nodes is larger.

In some embodiments, different tidal types correspond to different optimal counts of nodes. The semidiurnal tide (two rises and falls per day, with a relatively short period and steep waveform) corresponds to a moderate optimal count of nodes. The mixed tide (sometimes one rise and fall, sometimes two, with strong asymmetry and complex fluctuations) corresponds to a larger optimal count of nodes. The diurnal tide (one rise and fall per day, with a relatively long period and gentle waveform) corresponds to a smaller optimal count of nodes.

In some embodiments, the optimal count of nodes is positively correlated with the tide height change rate. More rapid change of tide height per unit time results in a steeper divided difference interpolation curve (reflecting a trend of tide height change over time). More nodes are required at this time to accurately match a rapid fluctuation pattern of tide height within a short time, i.e., the optimal count of nodes is larger, to reduce the deviation between a divided difference interpolation result and an actual tide height.

In some embodiments, the optimal count of nodes is positively correlated with the time offset. A greater distance between the nearest whole hour moment and the overpass time of the satellite remote sensing image, i.e., a larger time offset, results in a larger time span for extrapolation (estimating tide height outside whole hours) or interpolation (completing tide height between whole hours) during divided difference interpolation calculation. The possibility of prediction error is higher. Therefore, the count of nodes needs to be increased, i.e., the optimal count of nodes is larger, to make the divided difference interpolation result more stable and better fit the actual tide height change.

In some embodiments, the preset table may be constructed by the processor based on historical data. For example, the processor may collect records of a large number of historical satellite bathymetry inversion cases (referred to as historical cases) from different sea areas and different historical periods. The processor may process all historical cases one by one. For each historical case, the processor may perform divided difference interpolation calculation using different counts of nodes n (e.g., n=2, 4, 6). The processor may calculate instantaneous tide heights corresponding to a plurality of moments in the historical case. The processor may compare the instantaneous tide heights corresponding to the plurality of moments with measured tide heights from a tide gauge station corresponding to the plurality of moments one by one. The processor may filter a node count n with an optimal fitting effect (i.e., a minimum sum of numerical differences between the instantaneous tide heights at the plurality of moments and the measured tide heights) as the optimal count of nodes. Meanwhile, historical submarine topography complexity, a historical tidal type, a historical tide height change rate, and a historical time offset corresponding to the historical case are extracted as input features, a mapping relationship is established between the input features and a corresponding optimal count of nodes n, and the mapping relationship is filled into a table. After all historical cases complete the above processing and filling operations, the preset table is constructed.

Some embodiments of the present disclosure, by comprehensively considering the submarine topography complexity, the tidal type, the tide height change rate, and the time offset to dynamically match the optimal count of nodes for divided difference interpolation, can not only ensure fitting accuracy by increasing the count of nodes in complex scenarios with significant tidal nonlinearity, but also avoid numerical oscillation and overfitting by reducing the count of nodes in stable scenarios. The embodiments balance computational efficiency and inversion effect, achieving high accuracy and high stability in satellite instantaneous tide height calculation.

In some embodiments, the S3 further includes: based on the FNDWI normalized difference water index, generating a land-water mask image, and performing pixel-level spatial superposition of the land-water mask image and the satellite remote sensing image; and physically excluding pixel spectral data corresponding to a non-water area from the satellite remote sensing image, retaining and splicing pixel spectral data corresponding to a water area, and combining to generate a remote sensing image including only the pixel spectral data corresponding to the water area.

In some embodiments, a water area is composed of a plurality of water body pixels, and pixel spectral data of the plurality of water body pixels corresponds to pixel spectral data of the water area. A non-water area is composed of a plurality of non-water-body pixels, and pixel spectral data of the plurality of non-water-body pixels corresponds to pixel spectral data of the non-water area.

More descriptions regarding the FNDWI normalized difference water index may be found in the foregoing description.

The land-water mask image refers to an image configured to distinguish water areas and non-water areas in the satellite remote sensing image.

In some embodiments, the processor may use, via an image processing program and for each pixel in the satellite remote sensing image, a corresponding FNDWI normalized difference water index as a determination basis to determine whether the pixel is a water body pixel. If the FNDWI normalized difference water index is greater than 0, the pixel is determined to be a water body pixel: otherwise, the pixel is determined to be a non-water-body pixel. The determination result is encoded as an image pixel value (a water body pixel is assigned a value of 1, and a non-water-body pixel is assigned a value of 0) to output a binary image that spatially corresponds exactly to the satellite remote sensing image. The binary image is the land-water mask image.

In some embodiments, a manner of pixel-level spatial superposition by the processor may be: first, spatially aligning the land-water mask image and the satellite remote sensing image (e.g., matching pixel resolution, coordinates, etc. of the land-water mask image and the satellite remote sensing image); and then, based on the aligned spatial positions, the processor performs bitwise superposition of corresponding pixels of the land-water mask image and the satellite remote sensing image.

In some embodiments, after completing pixel-level spatial superposition of the land-water mask image and the satellite remote sensing image, the processor may perform pixel-level screening for each pixel. If an image pixel value corresponding to the pixel is 0, i.e., the pixel is a non-water-body pixel, the pixel spectral data of the non-water-body pixel is excluded. If the image pixel value corresponding to the pixel is 1, i.e., the pixel is a water-body pixel, the pixel spectral data of the water-body pixel is extracted. All extracted pixel spectral data of the water-body pixels (i.e., pixel spectral data corresponding to the water-body regions) is retained and spliced to combine and generate the remote sensing image including only the pixel spectral data corresponding the water area.

The pixel spectral data refers to vector data composed of reflectance of a pixel in each band of the satellite remote sensing image.

Some embodiments of the present disclosure, by generating the land-water mask image, performing the pixel-level spatial superposition of the land-water mask image and the satellite remote sensing image, and physically excluding the pixel spectral data of non-water area in the satellite remote sensing image while retaining only pixel spectral data of water area, thereby effectively improving training accuracy of a subsequent optimal ratio-logarithmic model for bathymetry inversion.

In some embodiments, the S3 further includes: for each pixel of the remote sensing image including only the pixel spectral data corresponding to the water area, performing neighborhood comparison to identify a discontinuous pixel; wherein the discontinuous pixel is a pixel for which a difference between the FNDWI normalized difference water index and the FNDWI normalized difference water index of a neighboring pixel exceeds a preset threshold; and physically excluding pixel spectral data corresponding to the discontinuous pixel from the remote sensing image including only the pixel spectral data corresponding to the water area, retaining and splicing pixel spectral data corresponding to a continuous pixel, and combining to generate a cleaned remote sensing image including pixel spectral data of a continuous water area.

In some embodiments, for each pixel of the remote sensing image including only pixel spectral data corresponding to the water area, the processor may obtain, with the pixel as a center, other pixels within a neighborhood window (e.g., a 3×3 pixel matrix) as adjacent pixels of the pixel, and calculate an average value of FNDWI normalized difference water indices of the adjacent pixels. An absolute value of a difference between the average value and the FNDWI normalized difference water index of the pixel is calculated. If the absolute value exceeds a preset threshold, the pixel is determined to be a discontinuous pixel. Pixel spectral data corresponding to each discontinuous pixel in the remote sensing image including only pixel spectral data of the water area is physically excluded from the remote sensing image including only pixel spectral data of the water area. Pixel spectral data corresponding to remaining continuous pixels is retained and spliced to combine and generate a cleaned remote sensing image including pixel spectral data of a continuous water area.

The preset threshold refers to a critical value of the FNDWI normalized difference water index configured to determine whether a pixel is a discontinuous pixel. In some embodiments, the preset threshold may be preset manually. The preset threshold is configured to determine whether the difference between the FNDWI normalized difference water index of a current pixel and the average value of FNDWI normalized difference water indices of the neighborhood window is significant. A smaller preset threshold indicates a stricter determination of water-body continuity.

Some embodiments of the present disclosure, by performing neighborhood comparison on a remote sensing image of the water area to identify and exclude discontinuous pixels with abrupt changes in the FNDWI normalized difference water index, remove noise pixels caused by interference such as marine debris, improve data continuity and spectral purity for bathymetry inversion modeling, and thereby enhance stability and accuracy of training an optimal ratio-logarithmic model for bathymetry inversion.

In some embodiments, the method for multispectral remote sensing stochastic optimal ratio-logarithmic bathymetry inversion further includes: extracting a blue band reflectance and a green band reflectance of each pixel from the cleaned remote sensing image including the pixel spectral data of the continuous water area; based on the blue band reflectance and the green band reflectance of each pixel, inverting bathymetric data of the target region through the optimal ratio-logarithmic model for bathymetry inversion; and transmitting the bathymetric data of the target region to a shipborne computer terminal, and controlling the shipborne computer terminal to render and generate a seafloor topographic map.

In some embodiments, the processor may, for each pixel in the cleaned remote sensing image including pixel spectral data of the continuous water area, read a surface true reflectance value corresponding to the pixel from a blue band channel and a green band channel of the remote sensing image, respectively, to obtain the blue band reflectance and the green band reflectance of each pixel.

In some embodiments, the processor may pair the blue band reflectance and the green band reflectance of each pixel to form a feature vector, use the feature vector as an input parameter of the optimal ratio-logarithmic model for bathymetry inversion, thereby inverting bathymetric data of the target region.

The seafloor topographic map refers to a two-dimensional or three-dimensional map constructed based on inverted bathymetric data and may be configured to visually display submarine topographic relief of the target region. For example, the seafloor topographic map may include a bathymetric contour map, a bathymetric heat map, a three-dimensional submarine view, or the like.

In some embodiments, the processor may first encapsulate the inverted bathymetric data into a data packet and transmit the data packet to the shipborne computer terminal via a wireless or wired communication link. After the shipborne computer terminal receives the data, the shipborne computer terminal invokes a graphics rendering engine, maps corresponding color gradients and contours based on the bathymetric data, and finally draws and displays in real time on a display screen the seafloor topographic map reflecting a submarine relief state.

Some embodiments of the present disclosure, by extracting blue band reflectance and green band reflectance of cleaned water-body pixels, inverting bathymetric data using the optimal ratio-logarithmic model for bathymetry inversion optimized by the extreme gradient boosting manner, transmitting the data to an shipborne terminal, and rendering the data as the seafloor topographic map, so as to enable the remote sensing data to directly serve ship operations, thereby improving underwater environment awareness and ship automation level.

The foregoing embodiments are merely used to illustrate the present disclosure and are not intended to limit the present disclosure. A person of ordinary skill in the relevant technical field may make various changes and modifications without departing from the spirit and scope of the present disclosure. Therefore, all equivalent technical solutions also fall within the scope of the present disclosure. The scope of patent protection of the present disclosure should be defined by the claims.

Technical content not described in detail in the present disclosure is well-known technology.

What is claimed is:

1. A method for multispectral remote sensing stochastic optimal ratio-logarithmic bathymetry inversion, comprising:
S1: since a water body signal is generally less than 5%, constructing an atmospheric coupled radiometric calibration correction model by comprehensively considering influences of a solar spectrum, an upward total scattering, a solar zenith angle, a total global transmittance, a direct irradiance, and a total spherical albedo to correct an atmospheric reflectance and a water surface reflectance, as shown in formula (1):
$$ρ = {( {( {x}_{a} \cdot ( {DN}_{i} \cdot {Gain}_{i} + {Bias}_{i} ) - {x}_{b} )}^{- 1} + {x}_{c} )}^{- 1} ; \qquad ( 1 )$$
wherein i denotes an i-th band; DN; denotes a gray value of the i-th band; Gainⱼ denotes an absolute calibration gain value of the i-th band; Biasᵢ denotes an offset value of the i-th band; ρ denotes a surface true reflectance after atmospheric coupled radiometric calibration correction; xₐ, x_{b}, and x_{c} denote atmospheric correction coefficients calculated by the atmospheric coupled radiometric calibration correction model;
wherein the atmospheric correction coefficients xₐ, x_{b}, and x_{c} are obtained by formula (2):
$$\{ \begin{matrix}{x}_{a} = \frac{π * ( {S}_{b} ) * ( {S}_{eb} ) * ( {S}_{utott} )}{cos ( \frac{{Z}_{enith} * π}{180} ) * ( {T}_{s} ) * ( {S}_{dtott} )} \\ {x}_{b} = \frac{( {A}_{inr} ) * ( {S}_{dtott} )}{( {T}_{s} ) * ( {S}_{utott} )} \\ {x}_{c} = {S}_{ast}\end{matrix} ; \qquad ( 2 )$$
wherein S_{b} (funct filter) denotes a functional filter, S_{eb} (sol spect) denotes the solar spectrum, Sᵤₜₒₜₜ (upward total scattering) denotes the upward total scattering, Zₑₙᵢₜₕ denotes the solar zenith angle, Tₛ(total global transmittance) denotes the total global transmittance, S_{dtott} (downward total scattering) denotes a downward total scattering, Aᵢₙᵣ (direct irradiance) denotes the direct irradiance, and Sₐₛₜ(total spherical albedo) denotes the total spherical albedo;
S2: based on an overpass time of a satellite remote sensing image, constructing a divided difference interpolation tide height correction model to obtain an instantaneous tide height, and a tide height correction is performed using formula (3):
$${d}_{t} = {d}_{m} + ( {d}_{d} - {d}_{H} ) ; \qquad ( 3 )$$
wherein dₜ denotes instantaneous bathymetric data, dₘ denotes measured bathymetric data, d_{d} denotes a difference between a mean sea level and a tidal datum, and d_{H} denotes a tide height value; wherein d_{H}(x) is obtained by a divided difference interpolation transformation:
$${d}_{H} ( x ) = f [ {x}_{0} ] + ( x - {x}_{0} ) f [ {x}_{0} , {x}_{1} ] + ( x , {x}_{0} ) ( x - {x}_{1} ) \cdot f [ {x}_{0} , {x}_{1} , {x}_{2} ] + … + ( x - {x}_{0} ) ( x - {x}_{1} ) … ( x - {x}_{n - 1} ) f [ {x}_{0} , {x}_{1} , … {x}_{n} ] ;$$
wherein x denotes an overpass time
$$[ \frac{n}{2} ]$$
of the satellite remote sensing image, x₀ denotes a 0-th whole hour moment earlier than the overpass time of the satellite remote sensing image, x₁ denotes a first whole hour moment of the overpass time of the satellite remote sensing image, x₂ denotes a second whole hour moment of the overpass time of the satellite remote sensing image, xₙ₋₁ denotes an (n−1)-th moment later than the overpass time of the satellite remote sensing image, and xₙ denotes an n-th moment later than the overpass time of the satellite remote sensing image; tide height data ƒ[x₀, x₁, . . . , xₙ], i=0.1, . . . , n corresponding to a plurality of known whole hour moments are known; to obtain d_{H}(x), divided differences of various orders at the plurality of known whole hour moments of ƒ(x) are calculated, and the divided differences are as shown in the following table:

| | | First-order | Second-order | Third-order | N-th order |
|---|---|---|---|---|---|
| | | divided | divided | divided | divided |
| xᵢ | f(xᵢ) | difference | difference | difference | difference |
| x₁ | f(x₁) | | | | |
| x₂ | f(x₂) | f[x₀, x₁] | | | |
| x₃ | f(x₃) | f[x₁, x₂] | f[x₀, x₁, x₂] | | |
| x₄ | f(x₄) | f[x₂, x₃] | f[x₁, x₂, x₃] | f[x₀, x₁, x₂, x₃] | |
| . . . | | | | | |
| xₙ | f(xₙ) | f[xₙ₋₁, xₙ] | f[xₙ₋₂, xₙ₋₁, xₙ] | f[xₙ₋₃, xₙ₋₂, xₙ₋₁, xₙ] | f[x₀, x₁, . . . xₙ] |

S3: when extracting water body information, since a near-infrared band pixel is contaminated by ground object information, by combining a characteristic of a low surface shortwave infrared band reflectance, constructing an FNDWI normalized difference water index to accurately extract a water body range:
$$FNDWI = \frac{{R}_{rs green} - {R}_{rs SWIR}}{{R}_{rs green} + {R}_{rs SWIR}} ; \qquad ( 4 )$$
wherein R_{rs green} and R_{rs SWIR} denote a green band reflectance and a shortwave infrared band reflectance in the satellite remote sensing image, respectively;
determining whether a pixel is a water body based on a threshold 0, in response to determining that a pixel where the FNDWI is greater than the threshold 0, classifying the pixel as the water body, and then performing a land-water mask;
S4: constructing a data set based on an image and bathymetric data at the overpass time of the satellite remote sensing image:
$$D = \{ ( {x}_{1} , {y}_{1} ) , ( {x}_{2} , {y}_{2} ) , … , ( {x}_{i} , {y}_{i} ) \} , i = 1 , 2 , … , N ;$$
wherein xᵢ=[Rᵣₛ(blue)ᵢ, Rᵣₛ(green)ᵢ] denotes an i-th input data feature; yᵢ denotes a target region value corresponding to a remote sensing data feature, i.e., measured bathymetric data after the tide height correction;
S5: constructing an optimal ratio-logarithmic model for bathymetry inversion; optimizing the optimal ratio-logarithmic model for bathymetry inversion by a random algorithm;
S5-1: constructing a ratio-logarithmic model:
$$Z = A \cdot ln \frac{L ( {λ}_{i} )}{L ( {λ}_{j} )} - B ; \qquad ( 5 )$$
wherein A is a scale adjustment constant of a ratio for bathymetry, λᵢ is the green band, λⱼ is a blue band, L(λᵢ) is a water body reflectance at a water depth Z for the green band, L(λᵢ) is a water body reflectance at the water depth Z for the blue band, and B is an offset relative to a water depth at a 0 m water level:
S5-2: constructing a stochastic optimal value selection model to find an optimal model parameter data set, and obtaining values of A and B with a minimum error:
$$T ( x ) = P ( x ) \cdot S ( x ) + ( 1 - P ( x ) ) \cdot ( e ( x ) + T ( x ) ) ; \qquad ( 6 )$$
$$Further :$$
$$T ( x ) = S ( x ) + \frac{1 - P ( x )}{P ( x )} \cdot e ( x ) ; \qquad ( 7 )$$
wherein x is a bathymetric value of a training set; P(x)>0 is a probability of obtaining a minimum difference between A and B; T(x) is a time required to find the minimum difference; and S(x) and e(x) are times required to find a maximum or the minimum difference between A and B;
S5-3: constructing an extreme gradient boosting manner to optimize model parameters; based on the dataset
$$D = {( {x}_{i} , {y}_{i} )}_{i = 1}^{N}$$
in S5-2, optimizing the model parameters, wherein xᵢ=[Rᵣₛ(blue)ᵢ, Rᵣₛ(green)ᵢ] in the dataset represents an i-th input data feature; and yᵢ represents corrected bathymetric data of the target region corresponding to the remote sensing data feature, a specific formula for optimizing the model parameters is shown in (8):
$$G ( ∅ ) = {\sum }_{i = 1}^{N} f ( {Z}_{i} , {\hat{Z}}_{i} ) + {\sum }_{k = 1}^{U} Ω ( {V}_{k} ) ; \qquad ( 8 )$$
wherein Zᵢ is a predicted bathymetry value of the ratio-logarithmic model; ƒ is a loss function, which is usually a mean squared error; and Ω is a regularization term for controlling a complexity of the ratio-logarithmic model;
for each tree Ω(Vₖ), there is:
$$Ω ( {V}_{k} ) = γ \cdot U + \frac{1}{2} θ \cdot {\sum }_{j = 1}^{U} {{ω}_{j}}^{2} ; \qquad ( 9 )$$
wherein U is a count of leaf nodes of the tree; ωⱼ is a weight of each leaf node; and γ and θ are hyperparameters for controlling a complexity of the ratio-logarithmic model; gradient boosting lies in adding a new tree each time to fit a residual of a current ratio-logarithmic model;
wherein an output of the new tree is a fit to the residual, thereby updating the ratio-logarithmic model;
$${W}_{i} = {Z}_{i} - {\hat{Z}}_{i}^{( U )} . \qquad ( 10 )$$

2. The method for multispectral remote sensing stochastic optimal ratio-logarithmic bathymetry inversion according to claim 1, wherein the S2 further includes:
based on a submarine topography complexity, a tidal type, a tide height change rate of the target region, and a time offset between a nearest whole hour moment and the overpass time of the satellite remote sensing image, determining an optimal count of nodes for divided difference interpolation by querying a preset table.

3. The method for multispectral remote sensing stochastic optimal ratio-logarithmic bathymetry inversion according to claim 1, wherein the S3 further includes:
based on the FNDWI normalized difference water index, generating a land-water mask image, and performing pixel-level spatial superposition of the land-water mask image and the satellite remote sensing image; and
physically excluding pixel spectral data corresponding to a non-water area from the satellite remote sensing image, retaining and splicing pixel spectral data corresponding to a water area, and combining to generate a remote sensing image including only the pixel spectral data corresponding to the water area.

4. The method for multispectral remote sensing stochastic optimal ratio-logarithmic bathymetry inversion according to claim 3, wherein the S3 further includes:
for each pixel of the remote sensing image including only the pixel spectral data corresponding to the water area, performing neighborhood comparison to identify a discontinuous pixel; wherein the discontinuous pixel is a pixel for which a difference between the FNDWI normalized difference water index and the FNDWI normalized difference water index of a neighboring pixel exceeds a preset threshold; and
physically excluding pixel spectral data corresponding to the discontinuous pixel from the remote sensing image including only the pixel spectral data corresponding to the water area, retaining and splicing pixel spectral data corresponding to a continuous pixel, and combining to generate a cleaned remote sensing image including pixel spectral data of a continuous water area.

5. The method for multispectral remote sensing stochastic optimal ratio-logarithmic bathymetry inversion according to claim 4, wherein the method further comprises:
extracting a blue band reflectance and a green band reflectance of each pixel from the cleaned remote sensing image including the pixel spectral data of the continuous water area;
based on the blue band reflectance and the green band reflectance of each pixel, inverting bathymetric data of the target region through the optimal ratio-logarithmic model for bathymetry inversion; and
transmitting the bathymetric data of the target region to a shipborne computer terminal, and controlling the shipborne computer terminal to render and generate a seafloor topographic map.
